(19) United States
(12) Patent Application Publication
(10) Pub. No.: US 2010/0225589 A1
(43) Pub. Date: Sep. 9, 2010

(54) MULTI-OBJECT SWITCH TRANSMISSION METHOD

(76) Inventor: Yu-Chun Hsieh, Taipei Hsien (TW)

Correspondence Address: Muncy, Geissler, Olds & Lowe, PLLC, 4000 Legato Road, Suite 310, FAIRFAX, VA, 22033, US

(21) Appl. No.: 12/717,479

(22) Filed: Mar. 4, 2010

(30) Foreign Application Priority Data
Mar. 6, 2009 (TW) 098107207

(51) Int. Cl. G06F 3/02; H04B 7/00; A63F 9/24

(52) U.S. Cl. 345/168; 455/41.3; 463/37; 455/556.2

(57) ABSTRACT

A multi-object switch transmission method to establish a data transmission linkage between an input device and at least one information process system includes: starting an object detection mode; obtaining a device identification code (Bd_address) and a device authorization code (pin_code) of the information process system to form a corresponding access relationship with a device selection code; judging whether to start anew the object detection mode; and establishing the data transmission linkage with the corresponding information process system based on the device selection code generated by a user. The device selection code is generated through the input device by depressing or other means so that the input device can search and access the corresponding device identification code and device authorization code through the device selection code. The device identification code and device authorization code are sent via wireless transmission to the corresponding information process system to establish the data transmission linkage.

### FIELD OF THE INVENTION

The present invention relates to a multi-object switch transmission method and particularly to a method to transmit input message to multiple information process systems through a wireless linking protocol.

### BACKGROUND OF THE INVENTION

Keyboard has become one of the necessary and basic output devices since the early development stage of computers. Although personal computers have gone through a great deal of progress these years, the keyboard still maintains substantially the same basic style. With improvements on material and structure, the size and weight of the keyboard have been reduced significantly in recent years. Composite keyboards that can be folded and expanded have been developed, and flexible keyboards that can be rolled and bent also are available. Many keyboards are being designed as portable computer accessories to facilitate carrying. However, there is still one constraint existed today that greatly limits the usability of the keyboard, i.e. communication between the conventional keyboard and a computer system has to rely on linkage of a signal cable. The signal cable usually has a limited length that restricts use distance and environment. To overcome this constraint, the approach of adopting wireless technology on the keyboard has been proposed in prior art. For instance, R.O.C. patent No. 510537 entitled “Wireless keyboard” discloses a technique to transmit signals to a computer through infrared rays or radio frequency (RF). While the keyboard adopted the wireless technique (mainly the infrared rays) to transmit signals has largely overcome the problem of the limited length of the signal cable. But the infrared ray also has its share of problems, e.g. it still has constraints on linking distance and angle and tends to be blocked by obstacles. Hence signal transmission is easily interrupted and results in errors.

In addition to the need of constant improvement over signal transmission, the application scope of the conventional keyboard also is too limited. In the past, applications of the conventional keyboard merely focus on computer systems. Before USB interface being widely adopted, the connection interface (such as PS2 terminal) of the keyboard can only be linked to a computer system. But users often have to enter data to information products other than computers. For instance, R.O.C. patent No. 532523 entitled “PDA externally connected to infrared keyboard” adopts a technique in which a back rack is provided on a keyboard to function as a PDA loading holder. The back rack also has an infrared ray emitter. When a PDA is held on the back rack, transmission quality between the infrared ray emitter and the PDA can be maintained in a stable manner. Thus input messages can be entered from the keyboard to the PDA, and input speed is much faster than directly entering data on the PDA.

In recent years, Bluetooth technology has been introduced to the keyboard. For instance, R.O.C. patent No. M341266 entitled “Keys and keyboard” discloses a technique that uses a conductive sheet to form a portion of an antenna. The conductive sheet is bonded to or clamped under a key cap, so that the key includes part of the antenna. It not only provides Bluetooth transmission function, also can save space.

Although the keyboard equipped with Bluetooth function is superior to infrared ray transmission, at present the Bluetooth-enabled keyboard is mainly limited to wireless transmission between the keyboard and a single device. The technique of selecting switch of linkage among multiple devices within the Bluetooth transmission range is still not being developed. There is still room for improvement on usability in terms of application scope and adaptable information products.

### SUMMARY OF THE INVENTION

In view of the aforesaid conventional techniques that still leave a lot to be desired, the present invention aims to provide an input device capable of linking to multiple information process devices and switching linking objects according to user's desire.

The present invention provides a multi-object switch transmission method to establish a data transmission linkage between an input device and at least one information process system. The method includes: starting an object detection mode; obtaining a device identification code (Bd_address) and a device authorization code (pin_code) of the information process system that form a corresponding access relationship with a device selection code; judging whether to start anew the object detection mode; and establishing a data transmission linkage according to the device selection code generated by a user and the corresponding information process system. The object detection mode aims to detect one information process system enabled for linkage, and through a two-way linkage with the information process system to get the device identification code (Bd_address) and device authorization code (pin_code). Next, judge again whether to start the object detection mode, if there are other information process systems can be linked, then get the device identification code (Bd_address) and device authorization code (pin_code) of other corresponding information process systems. If a user generates a device selection code by depressing a key or switching on the input device, the input device searches the corresponding device identification code (Bd_address) and device authorization code (pin_code) through the device selection code; and sends the device identification code (Bd_address) and device authorization code (pin_code) through wireless transmission to the corresponding information process system to establish the data transmission linkage. Thus the input device can perform data transmission with the selected information process system, i.e. user can enter input message through the input device via wireless transmission to the selected information process system. User also can change the chosen device selection code to alter the linking object of the input device. I.e. user can use one input device through selecting a key or a switch to perform data transmission to multiple objects. As a result, the invention enables users to enter information from one input device to different information process systems in different conditions, and can facilitate switching while maintaining the advantage of wireless transmission without cable constraint.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a procedure block diagram of the method of the invention.

FIG. 2 is a sub-procedure block diagram of the method of the invention.

FIG. 3 is another sub-procedure block diagram of the method of the invention.

FIG. 4 is a schematic view of the structure for implementation of the invention.

FIG. 5 is a circuit block diagram for implementation of the invention.

FIG. 6 is another circuit block diagram for implementation of the invention.

FIG. 7 is a first schematic view for implementation of the invention.

FIG. 8 is a second schematic view for implementation of the invention.

FIG. 9 is a third schematic view for implementation of the invention.

FIG. 10 is a fourth schematic view for implementation of the invention.

FIG. 11 is a fifth schematic view for implementation of the invention.

### DETAILED DESCRIPTION OF THE PREFERRED EMBODIMENTS

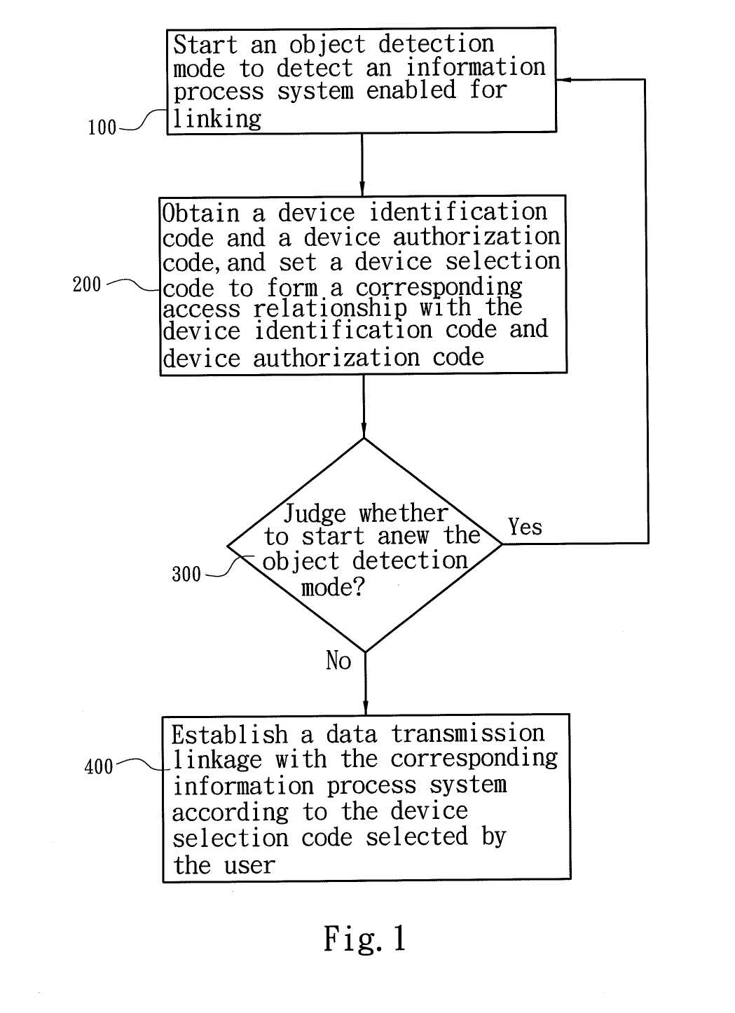

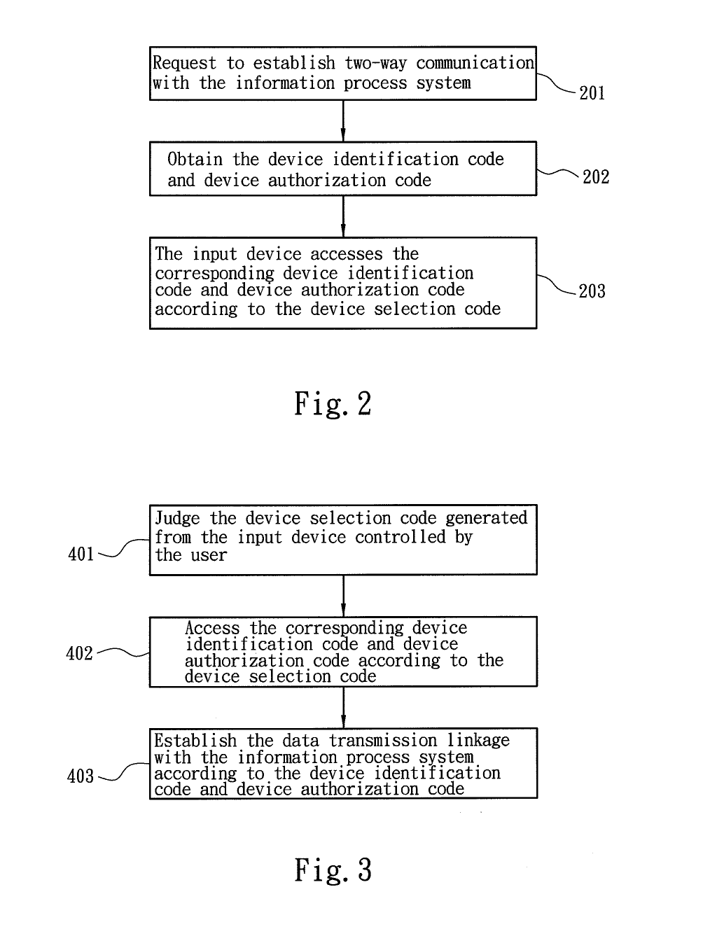

The present invention provides a multi-object switch transmission method to establish a data transmission linkage between an input device and at least one information process system through wireless transmission. Referring to FIG. 1, the method mainly includes: step 1: starting an object detection mode to detect an information process system enabled for linkage (step 100 in FIG. 1); step 2: obtaining a device identification code (Bd_address) and a device authorization code (pin_code) of the information process system, and setting a device selection code to form a corresponding access relationship with the device identification code (Bd_address) and the device authorization code (pin_code) (step 200 in FIG. 1); step 3: judging whether to start anew the object detection mode (step 300 in FIG. 1); if positive, back to step 2 to detect another information process system to be linked and get another set of device identification code (Bd_address) and device authorization code (pin_code); otherwise proceed step 4: accessing the corresponding device identification code (Bd_address) and device authorization code (pin_code) according to the device selection code generated by the user and establishing a data transmission linkage with the corresponding information process system (step 400 in FIG. 1). The steps set forth above are implemented through a wireless transmission technique, and more specifically via a wireless transmission protocol adopted IEEE 802.15.1, which is commonly called Bluetooth, i.e. through Bluetooth transmission technique can execute wireless data transmission between two electronic devices. The method provided by the invention controls the input device to start object detection mode to judge whether there is information process system enabled and available in the neighborhood to be linked (also equipped with Bluetooth function); if the detection outcome is positive, execute step 2 to get the device identification code (Bd_address), device authorization code (pin_code), and a device selection code of the input device corresponding to the two codes mentioned above. Step 2 further can be divided into following sub-steps: a. requesting to establish two-way communication with an information process system (sub-step 201 in FIG. 2); b. obtaining the device identification code (Bd_address) and device authorization code (pin_code) from the information process system (sub-step 202 in FIG. 2); and c. distributing a device selection code corresponding to the information process system so that the input device can access the corresponding device identification code (Bd_address) and device authorization code (pin_code) based on the device selection code (sub-step 203 in FIG. 2). Through the sub-steps a, b and c (201, 202 and 203), the input device can save the corresponding device identification code (Bd_address) and device authorization code (pin_code) of the information process system, and through the device selection code to form a corresponding data access relationship for accessing the device identification code (Bd_address) and device 20, authorization code (pin_code). It is to be noted that the device identification code (Bd_address) aims to allow a Bluetooth transmission device to judge the information process system to be linked, namely select a specific object among multiple objects according to the device identification code (Bd_address) to be linked; then through the pre-obtained device authorization code (pin_code) to establish the data transmission linkage with the information process system. Thereafter, return to step 3 of the method of the invention. At steps 1 and 2, while establishing the device identification code (Bd_address), device authorization code (pin_code) and device selection code on an information process system, there could be many other devices around the input device that can be linked via the Bluetooth transmission device, thus user can determine whether to start anew the object detection mode for other information process systems; then save another set of device identification code (Bd_address), device authorization code (pin_code) and device selection code. Thereafter, proceed step 4 to access the corresponding device identification code (Bd_address) and device authorization code (pin_code) according to the device selection code selected by the user to establish the data transmission linkage with the corresponding information process system. The step 4 further can be divided into sub-steps as follow: a: judging the device selection code generated from the input device controlled by the user (sub-step 401 in FIG. 3); b: accessing the device identification code (Bd_address) and device authorization code (pin_code) according to the device selection code (sub-step 402 in FIG. 3); and c: establishing two-way communication with the corresponding information process system according to the device identification code (Bd_address) and device authorization code (pin_code) and get authorization of the data transmission linkage to establish the data transmission linkage (sub-step 403 in FIG. 3). Through the sub-steps at step 4, user can select an object for transmitting signals and control the input device to establish the data transmission linkage with the selected object. The user can also select a different object anew and switch the linking object to transmit data in a wireless fashion. Moreover, one input device can be switched in use among multiple information process systems.

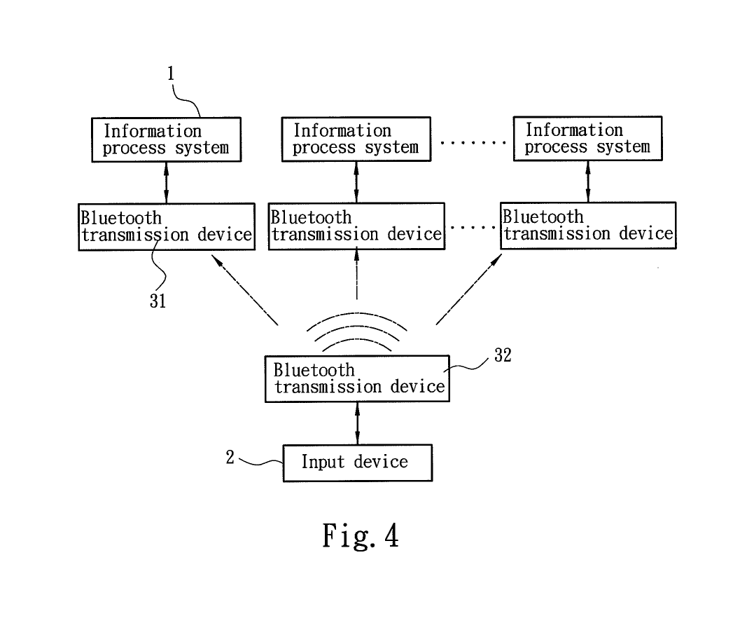

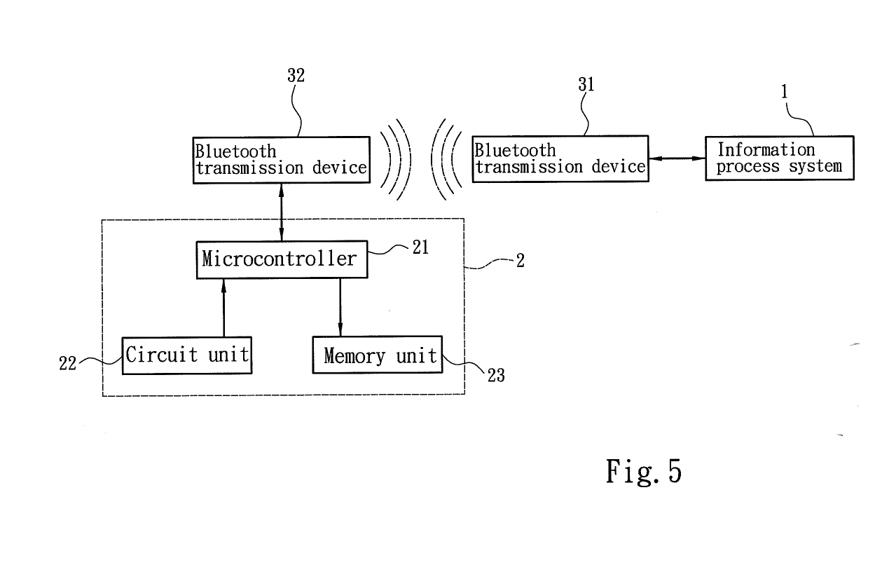

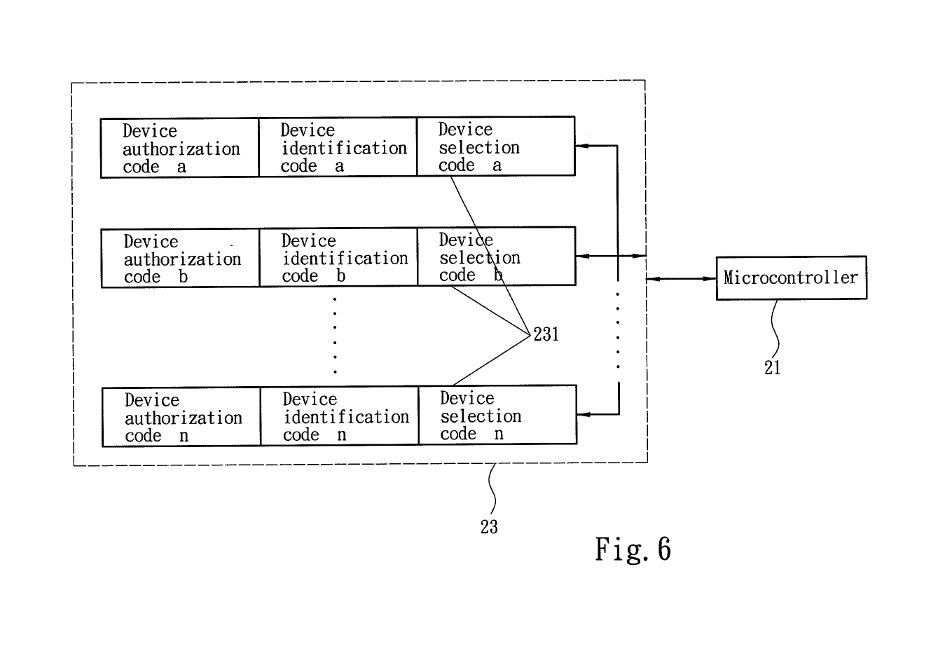

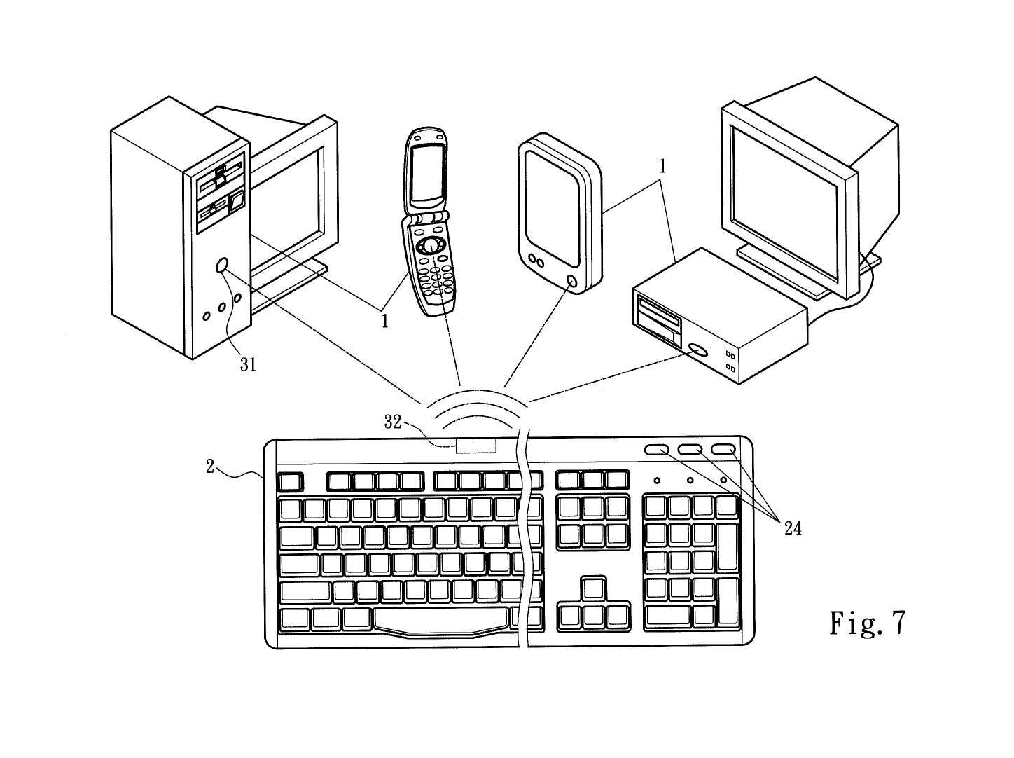

Please refer to FIG. 4 for an implementation structure of the method previously discussed. The structure includes multiple information process systems 1 and an input device 2 that are electrically and respectively connected to a Bluetooth transmission device 31 and 32. The Bluetooth transmission devices 31 and 32 can be external devices or built in the information process systems 1 or input device 2. The input device 2 is controlled by a user to detect the information process systems 1 can be linked in the neighborhood thereof, then gets the device identification code (Bd_address) and the device authorization code (pin_code) of each information process system 1 and forms a corresponding access relationship with the device selection code. The corresponding access relationship may be implemented through a protocol data column 231 (referring to FIG. 6). In the aforesaid embodiment, the input device 2 may be a keyboard. Referring to FIGS. 5 and 6, the keyboard includes a key set, a circuit unit 22 to generate electric signals upon depressing of the key set, a microcontroller 21 electrically connected to the circuit unit 22 to detect the electric signals and a memory unit 23 to store the device identification code (Bd_address), device authorization code (pin_code) and device selection code, and also electrically connected to the microcontroller 21. The microcontroller 21 can read and write data in the memory unit 23. Referring to FIG. 6, the device identification code (Bd_address), device authorization code (pin_code) and device selection code may form one protocol data column 231 in the memory unit 23. The microcontroller 21 accesses the device identification code (Bd_address) and device authorization code (pin_code) according to the device selection code. The memory unit 23 can store multiple sets of protocol data column 231. The microcontroller 21 detects the device selection code generated by the circuit unit 22 and accesses the corresponding protocol data column 231 from the memory unit 23, and according to the accessed device identification code (Bd_address) and device authorization code (pin_code) establishes the data transmission linkage through the Bluetooth transmission device 32 and the corresponding information process system 1; or writes a new protocol data column 231 to be chosen by users from the microcontroller 21.

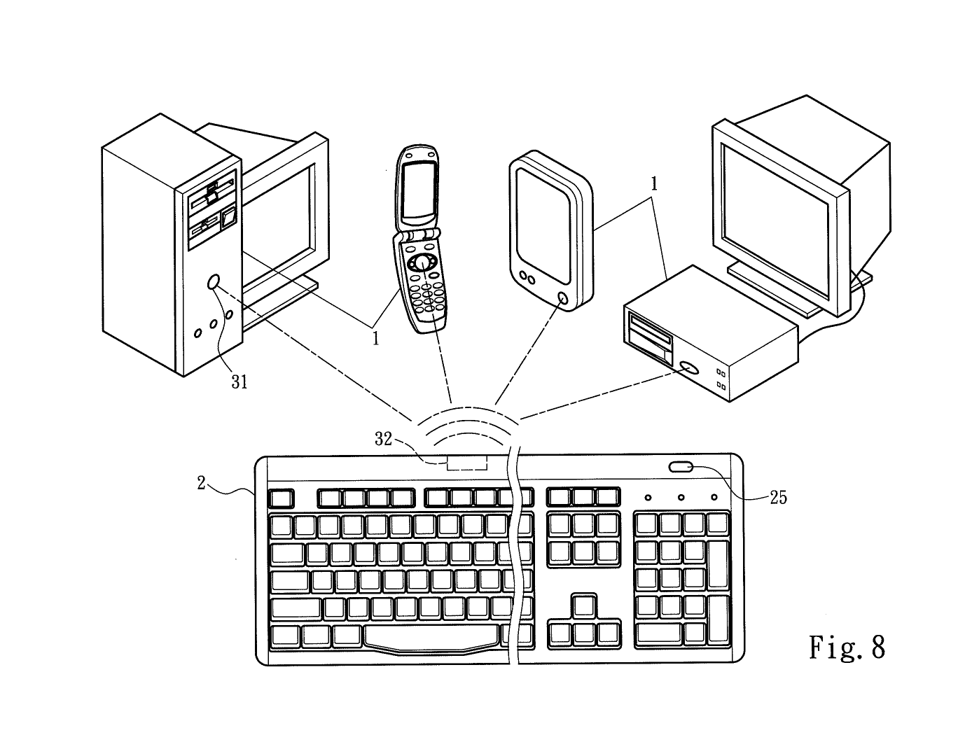

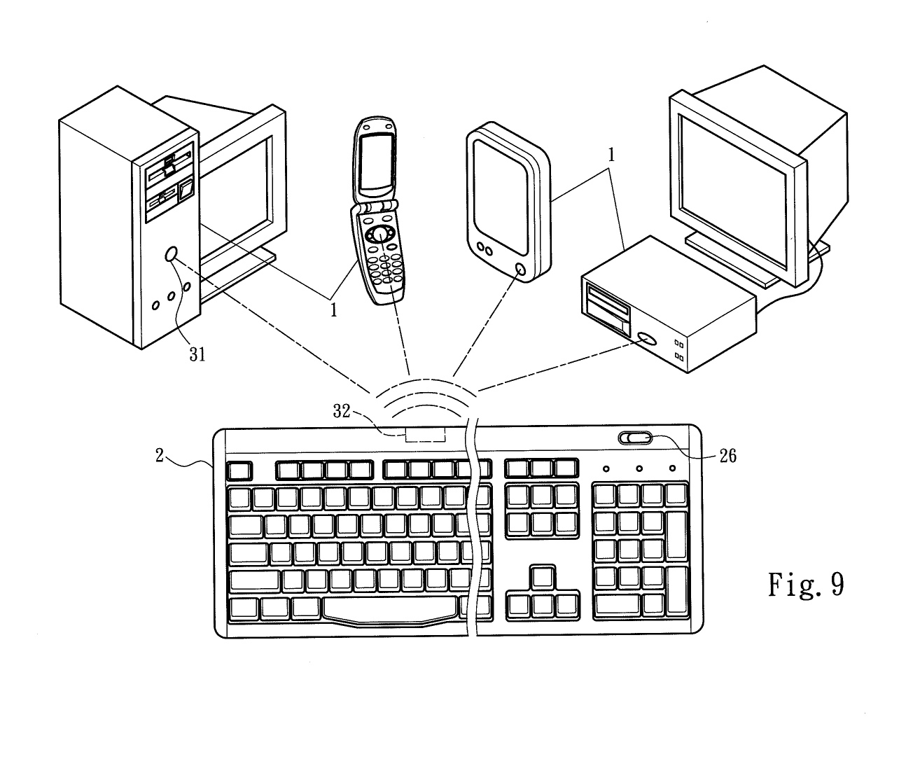

The circuit structure previously discussed may be adapted in various types of embodiments. Refer to FIGS. 7, 8 and 9 for embodiments in which the input device 2 is a keyboard. The keyboard includes a plurality of device switch keys 24 to trigger the circuit unit 22 in the keyboard to generate corresponding device selection codes. The microcontroller 21 located in the keyboard accesses the corresponding protocol data column 231 from the memory unit 23, and establishes the data transmission linkage through the device identification code (Bd_address) and device authorization code (pin_code) and a corresponding information process system 1. The keyboard may also include a switch function key 25 (referring to FIG. 8) to incorporate with depressing at least one key of the key set to generate a corresponding device selection code. For instance, the switch function key 25 may be depressed, then keys F1 through F5 may also be depressed at the same time to select one of five information process systems 1 to establish the data transmission linkage. The keyboard may also include a multi-stage switch 26 (referring to FIG. 9) which has multiple switch selection positions to trigger the circuit unit 22 to generate varying device selection codes. The information process system 1 can be a computer, a handset, a PDA, or a TV game machine. The computer may include a portable notebook computer.

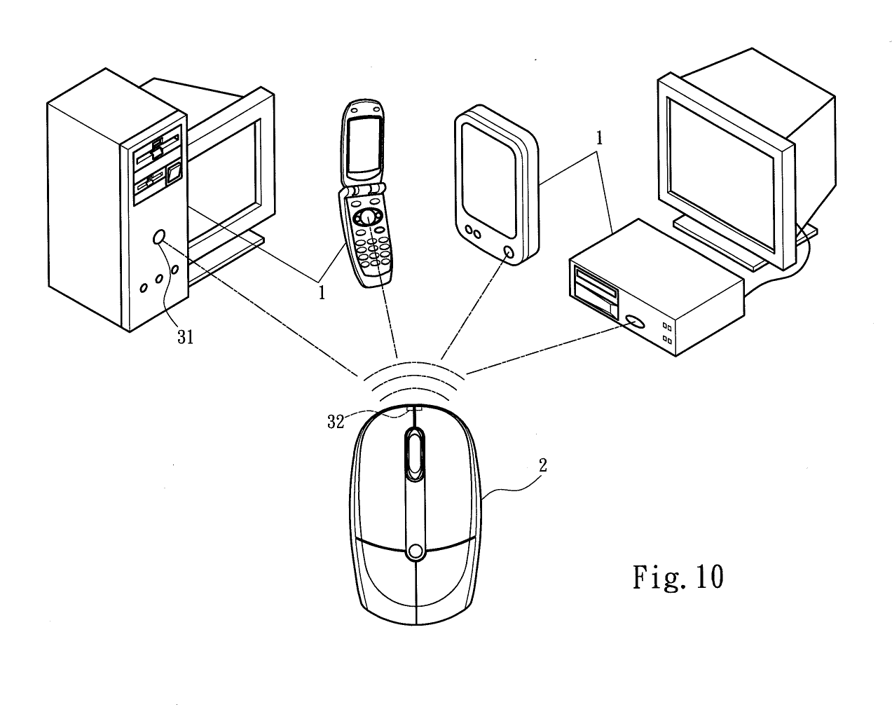

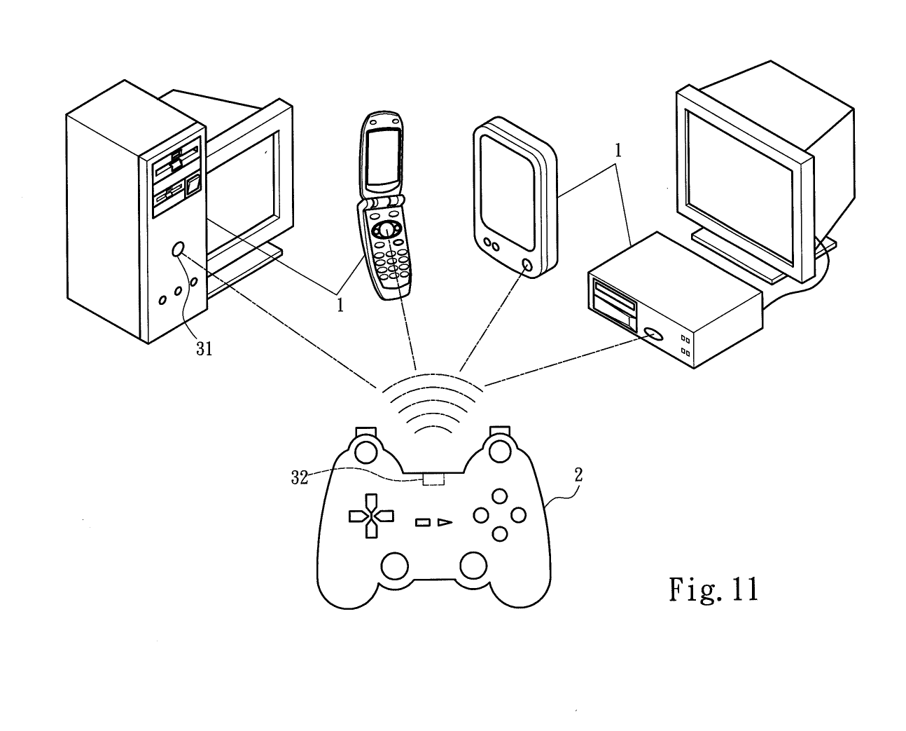

The input device 2 may be a mouse (referring to FIG. 10) or a game controller (referring to FIG. 11). The mouse or game controller has at least one button, a circuit unit 22 to generate electric signals upon depressing of the button, a microcontroller 21 to process the electric signals, a memory unit 23 to store the device identification code (Bd_address), device authorization code (pin_code) and device selection code and a Bluetooth transmission device 32 electrically connected to the microcontroller 21. By means of the method set forth above, user can input information through the input device 2 in different conditions to the information process system 1 selected by the user. Switching is easier and the advantage of wireless transmission can be maintained without cable limitation.

While the invention has been described by means of specific embodiments, they are not the limitations of the invention. The corresponding access relationship among the device identification code (Bd_address), device authorization code (pin_code) and device selection code can have different fashions through various software or program languages, such as address jump and the like. Since the way of data storage and access are not the focused features of the invention and the corresponding access methods are known to those skilled in computer program techniques, numerous modifications and variations could be made thereto by those skilled in the art without departing from the scope and spirit of the invention set forth in the claims.

In summation of the above description, the present invention provides a significant improvement over the conventional techniques and complies with the patent application requirements, and is submitted for review and granting of the commensurate patent rights.

What is claimed is:

1. A multi-object switch transmission method to establish a data transmission linkage between an input device and at least one information process system through wireless transmission, comprising the steps of:
step 1: starting an object detection mode to detect the information process system enabled for linking;
step 2: obtaining a device identification code and a device authorization code of the information process system and setting a device selection code to form a corresponding access relationship with the device identification code and the device authorization code;
step 3: judging whether to start the object detection mode again; returning to the step 2 to detect another information process system enabled for linking when judging outcome is positive to get another set of the device identification code and the device authorization code; otherwise proceeding the following step; and
step 4: accessing the corresponding device identification code and the device authorization code according to a device selection code generated by a user and establishing the data transmission linkage with the corresponding information process system.

2. The multi-object switch transmission method of claim 1, wherein the step 2 further includes sub-steps of:
a. requesting to establish two-way communication with the information process system;
b. obtaining the device identification code and the device authorization code from the information process system; and
c. distributing the device selection code corresponding to the information process system to allow the input device to access the corresponding device identification code and the device authorization code according to the device selection code.

3. The multi-object switch transmission method of claim 1, wherein the step 4 further includes sub-steps of:
a. judging the device selection code generated from the input device controlled by the user;
b. accessing the corresponding device identification code and the device authorization code according to the device selection code; and
c. establishing the two-way communication with the corresponding information process system according to the device identification code and the device authorization code and getting authorization of the data transmission linkage to establish thereof

4. The multi-object switch transmission method of claim 1, wherein signals transmitted at steps 2 and 4 conform to IEEE 802.15.1 communication protocol standards.

5. The multi-object switch transmission method of claim 4, wherein the input device and the information process system are electrically connected respectively to a Bluetooth transmission device to implement the IEEE 802.15.1 communication protocol standards.

6. The multi-object switch transmission method of claim 5, wherein the input device is a keyboard.

7. The multi-object switch transmission method of claim 6, wherein the keyboard includes a key set, a circuit unit to generate electric signals upon depressing of the key set, a microcontroller electrically connected to the circuit unit to detect the electric signals and a memory unit electrically connected to the microcontroller to store the device identification code and the device authorization code; the microcontroller detects the device selection code generated by the circuit unit and accesses the corresponding device identification code and device authorization code from the memory unit, and establishes the data transmission linkage with the corresponding information process system according to the device identification code and the device authorization code via the Bluetooth transmission device.

8. The multi-object switch transmission method of claim 7, wherein the keyboard includes a plurality of device switch keys to trigger the circuit unit to generate device selection codes corresponding to the device switch keys.

9. The multi-object switch transmission method of claim 7, wherein the keyboard includes a switch function key mating to depress at least one key of the key set to generate the corresponding device selection code corresponding to the key.

10. The multi-object switch transmission method of claim 7, wherein the keyboard includes a multi-stage switch which includes multiple switch selection positions to trigger the circuit unit to generate varying device selection codes.

11. The multi-object switch transmission method of claim 5, wherein the input device is a mouse which includes at least one button, a circuit unit to generate electric signals upon depressing of the button, a microcontroller to process the electric signals, a memory unit to at least store the device identification code and the device authorization code and a Bluetooth transmission device electrically connected to the microcontroller.

12. The multi-object switch transmission method of claim 5, wherein the input device is a game controller which includes at least one button, a circuit unit to generate electric signals upon depressing of the button, a microcontroller to process the electric signals, a memory unit to store the device identification code and the device authorization code and a Bluetooth transmission device electrically connected to the microcontroller.

13. The multi-object switch transmission method of claim 1, wherein the information process system is a computer.

14. The multi-object switch transmission method of claim 13, wherein the computer is a portable notebook computer.

15. The multi-object switch transmission method of claim 1, wherein the information process system is a handset.

16. The multi-object switch transmission method of claim 1, wherein the information process system is a personal digital assistant (PDA).

17. The multi-object switch transmission method of claim 1, wherein the information process system is a TV game machine.
